(19) United States
(12) Patent Application Publication
(10) Pub. No.: US 2026/0185858 A1
(43) Pub. Date: Jul. 2, 2026

(54) SYSTEM AND FLOW SENSOR FOR MEASURING A FLOW OF A FLUID MEASURING MEDIUM

(71) Applicant: Innovative Sensor Technology IST AG, Ebnat-Kappel (CH)

(72) Inventors: Ralf Emanuel Bernhardsgrütter, Sulgen (CH); Jürgen Dorsch, Ebnat-Kappel (CH); Marcel Giger, Wattwil (CH); Jakob Schaab, Zürich (CH); Fabio Schraner, Basel (CH); Sandro Schwab, Oftringen (CH)

(21) Appl. No.: 19/131,003

(22) PCT Filed: Nov. 9, 2023
(86) PCT No.: PCT/EP2023/081238

§ 371 Date: May 19, 2025

(30) Foreign Application Priority Data
Nov. 18, 2022 (DE) 10 2022 130 615.1

(51) Int. Cl. G01F 5/00; G01F 15/14

(52) U.S. Cl. CPC G01F 5/00; G01F 15/14

(57) ABSTRACT

The invention relates to a flow sensor comprising:—a housing (100), wherein the housing (100) has an inlet channel (110) for receiving the fluid measuring medium, an outlet channel (120) for discharging the fluid measuring medium, a measuring channel (130) extending between the inlet channel (110) and outlet channel (120) and at least one secondary channel (140) extending between the inlet channel (110) and the outlet channel (120), and more particularly connected in parallel to the measuring channel (130);-a sensor element (200) arranged in the measuring channel (130) for sensing a physical measurement variable with regard to a flow of the fluid measuring medium; and -a first more particularly bolt-shaped closure element (300), wherein the first closure element (300) is designed and attached to the housing (100) such that the first closure element (300) can be moved in relation to a first fluid transfer (150) or a second fluid transfer (160) into at least one first position (P1) and a second position (P2), wherein the first closure element (300), in the second position (P2), closes the first fluid transfer (150) or the fluid transfer (160), and wherein the first fluid transfer (150) or the second fluid transfer (160) is not closed in the first position (P1) of the first closure element (300), as well as a system that contains the flow sensor according to the invention.

The invention relates to a flow sensor for measuring a flow of a fluid measuring medium. Furthermore, the invention relates to a system comprising a control/evaluation unit and a flow sensor according to the invention.

Flow sensors are used for determining a flow rate or the flow velocity, the volume flow, the mass flow or related variables of a measuring medium, or a fluid, e.g., a gas, gas mixture, or a liquid. There are various types of flow sensors, for example thermal flow sensors, Coriolis flow sensors, ultrasonic flow sensors, microwave flow sensors, etc.

Thermal flow sensors, for example, make use of the fact that a (flowing) measuring medium transports heat away from a heated surface. Thermal flow sensors are typically composed of several functional elements, usually at least one low-impedance heating element and one high-impedance resistance element, which serve as a temperature sensor. Alternatively, thermal flow sensors are composed of several low-impedance heating elements, serving as heaters and temperature sensors.

Flow sensors and modules are designed for a certain flow range which is usually defined by the geometry of the flow channel. As a result, an adjustment must be made to the sensor or flow channel for each flow range. Depending on the application, individual adaptations of channel geometries are not desired, for example because the market is too small to motivate such an adaptation (this usually concerns small or medium quantities).

It is known from the prior art that a so-called “bypass” channel is used in which the flow sensor is located and which is fluidically connected parallel to the flow channel. The bypass channel allows the use of an identical sensor type in different applications. For this purpose, not the entire flow channel, but only the bypass channel must be geometrically adapted to the desired flow range.

However, even the adaptation of the bypass channel often involves effort and development, which is why such adaptation is often omitted, especially for smaller and medium-sized applications.

Proceeding from this problem, the object of the invention is to present a flow sensor which can be used in different flow ranges.

This object is achieved by a flow sensor according to claim 1 and by a system according to claim 11.

With regard to the flow sensor, it is provided that it is used to measure the flow of a fluid measuring medium and comprises:
a housing, wherein the housing has an inlet channel for receiving the fluid measuring medium, an outlet channel for discharging the fluid measuring medium, a measuring channel extending between the inlet channel and outlet channel and at least one secondary channel extending between the inlet channel and the outlet channel, and more particularly connected in parallel to the measuring channel, wherein a first fluid transfer is provided for connecting the inlet channel and the secondary channel, and wherein a second fluid transfer is provided for connecting the secondary channel and the outlet channel;
a sensor element arranged in the measuring channel for sensing a physical measurement variable with regard to a flow of the fluid measuring medium; and
a first bolt-shaped closure element, wherein the first closure element is designed and attached to the housing such that the first closure element can be moved in relation to the first fluid transfer or the second fluid transfer into at least one first position and a second position, wherein the first closure element, in the first position, closes the first fluid transfer or the fluid transfer, and wherein the first fluid transfer or the second fluid transfer is not closed in the second position of the first closure element.

The invention consists of providing a housing which forms a variable bypass channel. According to the invention, a main channel and at least one secondary channel are provided in the housing. The secondary channel can be closed at a first fluid transfer by at least one closure element, for example a piston, a bolt, a screw or the like. This allows the proportion of flow that flows through the measuring channel to be adjusted. This makes adjustments to the flow channel very easy and cost-effective to implement. The flow range can thus be defined according to the application and requirement.

Even applications that require very different flow values at times can be realized. Dosing pumps handle very small flow rates during dosing, but require large flow rates for the cleaning cycle. This is made possible by adjusting the closure element.

The measurement variable with regard to flow is understood to be, among other things, a measure of the flow velocity, the volume flow, the mass flow, etc., of the measuring medium.

One embodiment of the flow sensor provides a second bolt-shaped closure element which is designed and attached to the housing in such a way that the second closure element is movable into at least a first and a second position with respect to that first fluid transfer or second fluid transfer which is not influenced by the first closure element, wherein the second closure element closes this corresponding fluid transfer in the first position, wherein this corresponding fluid transfer is not closed in the second position of the second closure element. Here, the second closure element creates redundancy to the first closure element.

An advantageous embodiment of the flow sensor provides that the first closure element and/or the second closure element can be adjusted to intermediate positions between the first position and the second position. This means that the cross-section of the corresponding fluid transfer can be closed not only completely, but also partially in stages. This allows the division of the flow into the measuring channel and the secondary channel to be adjusted even more precisely so that the range of applications can be increased. By using both closure elements, wherein at least one of the closure elements is adjustable in intermediate stages, the flow division can be further refined.

An advantageous embodiment of the flow sensor provides that the first closure element and/or the second closure element is smoothly adjustable. This allows individual positioning of the corresponding closure element so that the flow range can be finely adjusted as required.

According to an advantageous embodiment of the flow sensor according to the invention, it is provided that the housing comprises one or more further secondary channels extending between the inlet channel and the outlet channel, and in particular connected parallel to the measuring channel, wherein for each further secondary channel, at least one further first fluid transfer is provided for connecting the inlet channel and the corresponding further secondary channel, and in each case one further second fluid transfer is provided for connecting the corresponding secondary channel and the outlet channel. The flowing fluid is thus divided between the measuring channel and all secondary channels. The first closure element is adjustable here into at least one third position, in which third position the first fluid transfer is closed together with at least one further first fluid transfer and/or together with all further first fluid transfers. A further position is provided for each further secondary channel in order to be able to close all secondary channels using the first closure element.

Furthermore, it is provided that the second closure element is designed and attached to the housing in such a way that the second closure element can be adjusted into at least one third position, in which third position the second fluid transfer is closed together with at least one further second fluid transfer and/or together with all further second fluid transfers. A further position is provided for each further secondary channel in order to be able to close all secondary channels using the first closure element.

By providing the further secondary channels and the corresponding further positions of the closure elements, a fine adjustment of the flow range is also made possible.

A variant of the flow sensor provides that for each further secondary channel, there is at least one further bolt-shaped closure element for closing the respective corresponding further first fluid transfer and/or further second fluid transfer. In this variant, therefore, a common closure element for the fluid transfers between the inlet channel and the secondary channels, or a common closure element for the fluid transfers between the secondary channels and the outlet channel, is not provided, but rather a separate closure element for each fluid transfer.

In an advantageous development, the flow sensor has an actuator which is designed and connected to the first closure element and/or to the second closure element in such a way that the actuator generates a movement of the first closure element or the second closure element for controlling the respective first positions, the second positions, the intermediate positions and the third positions. The closure elements are therefore not adjusted manually, but by the actuator. For this purpose, the actuator has a servo drive, in particular a motor.

Flow sensor according to any one of the preceding claims, wherein the flow sensor is a thermal flow sensor. The type and measuring principle (e.g., “constant temperature amemotry” (CTA), “constant power amemotry” (CPA), etc.) of the thermal flow sensor can be freely selected here.

With regard to the system, it is provided that it comprises a flow sensor according to the invention and a control/evaluation unit, wherein the control/evaluation unit is designed to query a measured value of the physical measurement variable with regard to the flow of the fluid measuring medium from the flow sensor and/or to adjust at least one of the closure elements to at least one of the positions by means of the actuator. The control/evaluation unit is, for example, a circuit with an ASIC or a microprocessor, or a PC or a mobile device, e.g., a smartphone or a tablet.

Advantageously, the control/evaluation unit is designed to compare the measured value with at least one limit value and, if the limit value is exceeded or undershot, to adjust at least one of the closure elements by means of the actuator in such a way that the measured value no longer falls below or exceeds the limit value. This creates a controller functionality that can be used advantageously, in particular under changing conditions such as a strongly fluctuating flow rate.

The invention is explained in greater detail with reference to the following figures. In the figures:

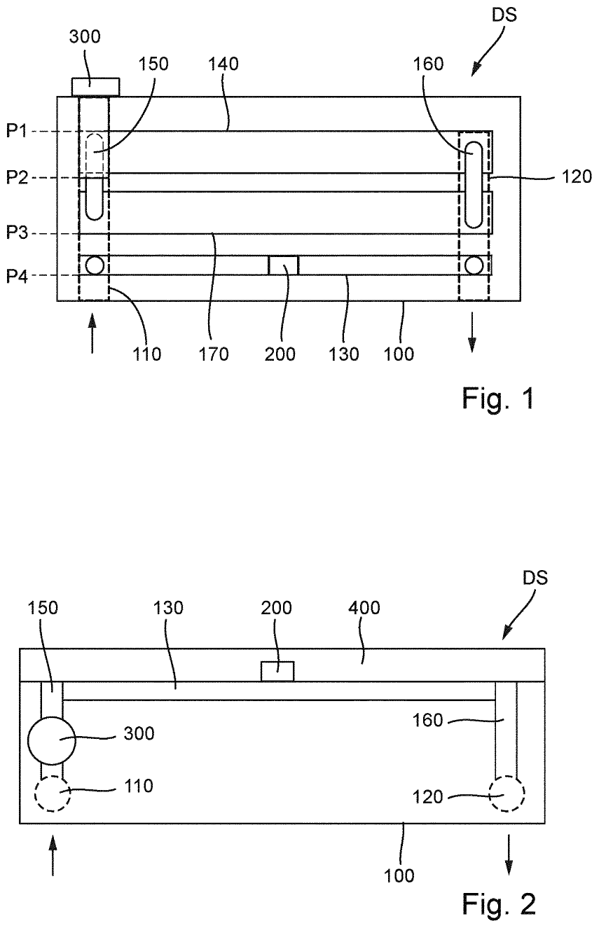

FIG. 1: is a horizontal cross-sectional view of a flow sensor described in a first exemplary embodiment;

FIG. 2: is a vertical cross-sectional view of the flow sensor described in the first exemplary embodiment;

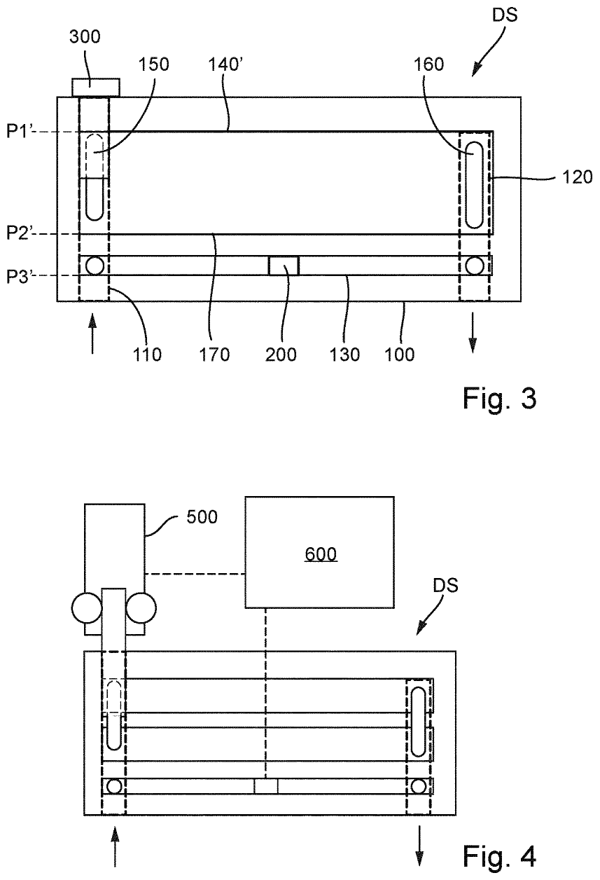

FIG. 3: is a horizontal cross-sectional view of a flow sensor described in a second exemplary embodiment; and

FIG. 4: is an exemplary embodiment of the system according to the invention.

FIGS. 1 and 2 show a first exemplary embodiment of the flow sensor DS according to the invention. FIG. 1 shows here a horizontal cross-section through the flow sensor 1, or a plan view of the flow sensor 1, in which the counterpiece 400 is omitted. FIG. 2 shows a cross-section through the flow sensor DS at the level of the measuring channel 130.

The flow sensor consists of a one-part or multi-part housing 100. In the case of a one-part housing 100, this consists of plastic, for example, and is manufactured by means of an additive manufacturing process, for example by means of 3D printing. In the case of a multi-part housing, this consists of a plastic or of a metal material.

Several channels are formed in the housing:

An inlet channel 110 and an outlet channel 120 are provided, by means of which a fluid measuring medium can be introduced into and discharged from the housing 100. The arrows show here the flow rate of the measuring medium. Furthermore, one measuring channel 130 and two secondary channels 140 are provided. First fluid transfers 150 connect here the inlet channel 110 and the secondary channels. Second fluid transfers 160 connect here the inlet channel 110 and the secondary channels. In addition, fluid transfers are also provided between inlet channel 110 and measuring channel 130 and between measuring channel 130 and outlet channel 120. The fluid transfers 150, 160 are provided here as holes in the material of the housing 100, which form channels between the corresponding secondary channels 140, 170 and inlet channel 110, or outlet channel 120. In the present example, the secondary channels each share a hole, but separate fluid transfers 150, 160 are still formed.

The flow sensor DS can therefore be connected to a flow channel and acts, for example, as a bypass channel to the flow channel.

A flow sensor 200, in particular a thermal flow sensor 200, is mounted in the measuring channel 130. This senses a measurement variable of the measuring medium flowing through the measuring channel, for example a measure of the flow rate, the volume flow, the mass flow, or similar.

The measurement variable measured by the flow sensor 200 in the measuring channel 130 is a measure of the flow rate, or volume flow and/or mass flow, of the measuring medium present in the flow channel. The flow sensor 200 is calibrated accordingly for this. Depending on the application, there are different size flow regimes in the flow channel. For this purpose, the geometry of the measuring channel 130 must be designed accordingly in order to avoid flows in the measuring channel 130 which can no longer be sensed by the flow sensor 200 due to a flow that is too high or too low. The flow sensor DS according to the invention offers the possibility of adjusting the flow regime in the measuring channel 130 without having to adapt the geometry of the measuring channel 130.

A first closure element 300 is provided for this purpose. In the present case, this has a bolt-shaped form and can be inserted into the housing 100. Depending on the position, i.e., the degree of penetration of the closure element 300 into the housing 100, one or more of the secondary channels 140, 170 can be closed. This is done by the closure element 300 crossing the corresponding first fluid connections 150 and closing their channel cross-section. This changes the pressure drop, which in turn changes the fluid distribution into the corresponding channels 130, 140, 170.

In a first position P1, the closure element 300 is inserted into the housing 100 to such an extent that the closure element 300 does not meet any of the fluid connections. The measuring medium flowing through the flow sensor DS is distributed proportionally to the measuring and auxiliary channels 130, 140, 170 according to the geometries of these measuring and auxiliary channels 130, 140, 170.

In a second position P2, the closure element 300 is inserted into the housing 100 to such an extent that the closure element 300 hits the fluid connection 150 connecting the inlet channel 110 to the secondary channel 140 and closes its cross-section completely. The measuring medium flowing through the flow sensor DS is thus only distributed to the measuring channel 130 and the further secondary channel 170, whereby a higher flow rate is present in these channels 130, 170 compared to position P1.

In a third position P3, the closure element 300 is inserted into the housing 100 to such an extent that the closure element 300 meets the fluid connection 150 connecting the inlet channel 110 to the secondary channel 140 and the fluid connection connecting the inlet channel 110 to the secondary channel 170 and completely closes their cross-sections. The measuring medium flowing through the flow sensor DS thus only flows through the measuring channel 130, whereby a higher flow rate is present in this measuring channel 130 compared to the positions P1 and P2.

In a fourth position P4, the closure element 300 is inserted into the housing 100 to such an extent that the closure element closes the cross-sections of all fluid connections of the channels 130, 140, 170. No more measuring medium flows through the flow sensor DS.

FIG. 3 shows a second exemplary embodiment of the flow sensor. This differs from the first exemplary embodiment in that not two secondary channels, but only a single large secondary channel 140′ is provided.

The closure element 300 can be moved in 3 positions:
In a first position P1′, the closure element 300 is inserted into the housing 100 to such an extent that the closure element 300 does not meet any of the fluid connections. The measuring medium flowing through the flow sensor DS is distributed proportionally to the measuring channel 130 and the secondary channel 140′according to the geometries of the measuring and secondary channels 130, 140′.
In a second position P2′, the closure element 300 is inserted into the housing 100 to such an extent that the closure element 300 hits the fluid connection 150 connecting the inlet channel 110 to the secondary channel 140 and closes its cross-section completely. The measuring medium flowing through the flow sensor DS thus only flows through the measuring channel 130, whereby a higher flow rate is present in this measuring channel 130 compared to position P1′.
In a third position P3′, the closure element 300 is inserted into the housing 100 to such an extent that the closure element 300 closes the cross-sections of all fluid connections of the channels 130, 140′. No more measuring medium flows through the flow sensor DS.

The second embodiment additionally offers the possibility of smoothly reducing the cross-section of the fluid connection 150. For this purpose, the closure element 300 can be adjusted to intermediate positions between the positions P1′ and P2′. This offers a degree of adaptability to different applications.

FIG. 4 shows an exemplary embodiment of the system according to the invention. The flow sensor DS corresponds here to that of the first exemplary embodiment (see FIG. 1 and FIG. 2). In addition, an actuator 500 is provided here which can move the closure element 300 in the housing 100 and set the positions P1, P2, P3, P4.

In addition, a control/evaluation unit 600 can be provided. This serves to query the measured value from the flow sensor 200 and to control the actuator to move the closure element 300 to the positions P1 to P4. A controller functionality can also be realized in which the control/evaluation unit 600 moves the closure element 200 according to the variables sensed by the flow sensor 200. For example, the positions are controlled when a limit value is exceeded or undershot so that the flow sensor would be “out-of-spec”. By controlling a suitable position, the flow sensor 200 is again in the desired specification range.

The invention is not limited to the listed exemplary embodiments and those shown in FIGS. 1 to 4. Combinations of the exemplary embodiments are also included. It is also possible to provide a second closure element which can close the second fluid connections (between the secondary channels and the outlet channel, or between the measuring channel and the outlet channel). It is also possible to provide a separate closure element for each of the fluid connections.

### LIST OF REFERENCE SIGNS

100 Housing
110 Inlet channel
120 Outlet channel
130 Measuring channel
140 Secondary channel
150 First fluid transfer
160 Second fluid transfer
170 Further secondary channel
200 Sensor element
300 Closure element
400 Counterpiece
500 Actuator
600 Control/evaluation unit
DS Flow sensor
P1 First position of the closure element
P2 Second position of the closure element
P3 Third position of the closure element

1-12. (canceled)

13. A flow sensor for measuring a flow of a fluid measuring medium including a housing, wherein the housing comprises:
an inlet channel for receiving the fluid measuring medium;
an outlet channel for discharging the fluid measuring medium;
a measuring channel extending between the inlet channel and the outlet channel;
at least one secondary channel extending between the inlet channel and the outlet channel, wherein a first fluid transfer connects the inlet channel and the at least one secondary channel, and a second fluid transfer connects the at least one secondary channel and the outlet channel;
a sensor element arranged in the measuring channel for sensing a physical measurement variable regarding the flow of the fluid measuring medium; and
a first closure element, wherein:
the first closure element is attached to the housing such that the first closure element can be moved in relation to the first fluid transfer or the second fluid transfer into at least one first position and a second position, wherein:
when the first closure element is in the second position, the first closure element closes the first fluid transfer or the second fluid transfer; and
when the first closure element is in the at least one first position, the first fluid transfer or the second fluid transfer is not closed.

14. The flow sensor according to claim 13 further comprising a second closure element, wherein:
the second closure element is attached to the housing such that the second closure element is movable into at least a first position and a second position with respect to the first fluid transfer or the second fluid transfer and is not influenced by the first closure element; and
the second closure element closes a corresponding fluid transfer when the second closure element is in the second position and the corresponding fluid transfer is not closed when the second closure element is in the first position.

15. The flow sensor according to claim 14, wherein the first closure element and/or the second closure element can be adjusted to intermediate positions between the first position and the second position.

16. The flow sensor according to claim 15, wherein the first closure element and/or the second closure element is/are continuously adjustable.

17. The flow sensor according to claim 13, wherein the housing further comprises one or more further secondary channels extending between the inlet channel and the outlet channel, wherein for each further secondary channel, at least one further first fluid transfer connects the inlet channel and the corresponding further secondary channel, and at least one further second fluid transfer connects the corresponding further secondary channel and the outlet channel.

18. The flow sensor according to claim 17, wherein the first closure element is attached to the housing such that the first closure element can be adjusted into at least one third position, wherein when the first closure element is positioned in the at least one third position, the first fluid transfer is closed and at least one further first fluid transfer and/or all further first fluid transfers are closed.

19. The flow sensor according to claim 17, wherein the second closure element is attached to the housing such that the second closure element can be adjusted into at least one third position, wherein when the second closure element is in the at least one third position, the second fluid transfer is closed and at least one further second fluid transfer and/or all further second fluid transfers are closed.

20. The flow sensor according to claim 17, wherein for each further secondary channel, the flow sensor further comprises at least one further bolt-shaped closure element to close the respective corresponding further first fluid transfer and/or further second fluid transfer.

21. The flow sensor according to claim 13, wherein the sensor element is a thermal flow sensor.

22. The flow sensor according to claim 15 further comprising an actuator, wherein the actuator is connected to the first closure element and/or to the second closure element such that the actuator generates a movement of the first closure element or the second closure element such that the first closure element or the second closure element can be positioned in the first position, the second position, the intermediate positions, and the third position.

23. A system comprising a flow sensor according to claim 22 and a controller, wherein the controller is embodied to evaluate a measured value from the physical measurement variable of the flow sensor concerning the flow of the fluid measuring medium and/or to instruct the actuator to position at least one of the first or second closure elements to at least one of the positions.

24. The system according to claim 23, wherein the controller is embodied to compare the measured value with at least one limit value and, when the at least one limit value is exceeded or undershot, to instruct the actuator to adjust at least one of the first or second closure elements such that the measured value no longer undershoots or exceeds the limit value.

25. The flow sensor according to claim 13, wherein the at least one secondary channel is connected in parallel to the measuring channel.

26. The flow sensor according to claim 13, wherein the first closure element is bolt-shaped.

27. The flow sensor according to claim 14, wherein the second closure element is bolt-shaped.

28. The flow sensor according to claim 17, wherein the one or more further secondary channels extending between the inlet channel and the outlet channel are connected parallel to the measuring channel.
